(19) United States
(12) Patent Application Publication
(10) Pub. No.: US 2007/0288574 A1
(43) Pub. Date: Dec. 13, 2007

(54) System and method of email streaming digital video for subscribers

(76) Inventors: Daren Koster, Kinnelon, NJ (US); Christoph Niemann, Kronberg (DE)

Correspondence Address: LOUIS VENTRE, JR, 2483 OAKTON HILLS DRIVE, OAKTON, VA, 22124-1530, US

(21) Appl. No.: 11/309,024

(22) Filed: Jun. 9, 2006

(51) Int. Cl. G06F 15/16

(52) U.S. Cl. 709/206

(57) ABSTRACT

A video email system and service for subscriber composed of (1) video email software residing on a subscriber's electronic device (110); (2) a server maintained by a provider to manage each subscriber's account and to stream the video on demand to an email recipient (120); and (3) a recipient computer capable of translating a pre-determined video file format and receiving email using any standard email program (130). The service enables a subscriber using the video email software to send a digital video made with any camera and converted by the pre-determined video file format to a recipient having a standard email program through the service provider's server. The server receives the video and sends a gateway email to the recipient with a frame for viewing the video. The server streams the video to the recipient upon demand of the recipient.

### FIELD OF INVENTION

In the field of electronic mail (email) messaging, a system and method of sending and receiving digital videos between spatially distributed electronic devices via the Internet.

### BACKGROUND OF THE INVENTION

Personal digital cameras have proliferated in the market and are widely used in the private sector. They serve to create personal records of personal events, such as births, birthday celebrations, weddings and other significant and insignificant events in one's life. Business too is employing digital videos to describe products and communicate with clients. However, while digital cameras are useful at recording events, sharing the digital file created with a digital camera is difficult essentially because of the digital video file size. For short clips, the file size could be manageable. However, a digital video file of an event can be many tens of megabytes and this size file often exceeds the capability of email systems. Having a simple and easy method of sending such files to others would greatly expand the use of video cameras and serve to meet the needs of those interested in sharing the digital video with others.

Digital video streaming is often employed from a web site to a user to convey a digital video so that the recipient may begin playback soon after the stream starts to arrive at the recipient's computer. Many news organizations now have web sites that have digital streams of video recorded events that can be downloaded by a viewer at the demand of the viewer. However, streaming has not generally been effective for email since it requires that both the sender and the receiver be synchronously linked to stream the video between them. This is inconsistent with the asynchronous nature of sending and receiving emails and the convenience of both sender and recipient of the email.

The variety of digital video camera formats can also be a significant barrier to effectively sharing digital video files. A file saved in one format might not be viewable on a third party's computer without special software for that particular video file format. However, a system for transferring a video in any video file format can be implemented with the present invention. However that video file format must be a pre-determined video file format so that the software can be made operational with that pre-determined video file format.

Most users today have an operating system and that system enables viewing video messages in ASF video file format. Other operating systems may also enable viewing video files in ASF video file format. So, any application empowering the use of ASF formatted videos will be suitable to a majority of computer users. Thus, the ASF video file format is close to standard format for encoded video data on a computer network and is used as the primary example of the video file format suited to this invention. However, it should be recognized that the invention is not limited to the use of ASF formatted video files, but rather is a system for video email services that can be implemented with any pre-determined video file format.

### DESCRIPTION OF THE PRIOR ART

Prior art describes superficially similar systems for streaming video with email that remain distinctly different from the present invention. While streaming video and even streaming video email is known, the prior art fails to provide a video email program in which the sender encodes a video in a single video file format, permits the sender to select the number of times the recipient may view the video, and permits the sender to account and pay for the cost of the video email. Prior art also either fails to describe an email system for sending or receiving streaming video, or requires the server to determine the multimedia characteristics of the recipient's computer, or both. The present invention describes an email system using a process simplified by the elimination of the need to determine the multimedia characteristics of the recipient's computer.

The present invention is a system applicable to almost any electronic device capable of an Internet connection and computer email operations, such as desktop and mobile computers, hand held cell phones, and digital cameras. There is nothing limiting digital cameras from employing an operable central processing unit and Internet communications capability to permit direct use of a digital camera for emailing whatever the camera captures. In all such applications, the electronic device is behaving like a computer and for purposes of this disclosure, computer is defined to include any type of electronic device capable of an Internet connection and computer email operations.

An example of streaming video through email is U.S. Pat. No. 6,795,863 to Thomas R. Doty, Jr. on Sep. 21, 2004. The '863 disclosure teaches that a video is digitized, compressed, encoded, and then stored and/or transmitted in or through a video server. A smart server that queries the computer and recognizes the recipient computer's client player/decoder then distributes the processed data. The smart server then encodes the video into a form that can be viewed by the recipient computer, ultimately converting to and sending a plurality of different video formats. The video screen for viewing the streaming video is embedded on the email web site so that the person using the email can view the streaming video while using the email. The email system also includes digital calendar data and simultaneously distributing the calendar data with the video data streams, thereby enabling the calendar data to be displayed simultaneously with the video data stream on the client recipient computers.

The present invention has a few similar elements to the '863 patent, but is different in the omission of key elements, and the inclusion of other elements accomplishing divergent purposes. The present invention neither encodes video data into a plurality of different formats; nor does it attempt to send in a plurality of different video data stream formats. Rather the present invention uses special sender email software that encodes and enables the transfer of a single video format.

The preferred embodiment of the invention uses MICROSOFT® Advanced Systems Format (hereinafter, ASF format), from the sender's computer to the server. MICROSOFT is a registered trademark of Microsoft Corporation. The ASF format is a file format and while it is a proprietary format, it is very close to a standard in the computer industry. It uses an audio and/or video content compressed with a wide variety of codecs and played back with many independent video viewing programs and computer operating systems. The special sender email software is further unique to the service provided by the invention because it regulates payment for the service and the number of times the video can be viewed by the recipient.

The '863 disclosure teaches a need for a smart server. The present invention does not send video data streams with different formats and so does not use a smart server to query the recipient's computer. The smart server is a key patentably distinct component of the '863 invention and is not used in the present invention.

The server in the present invention is intended to send a gateway email to the recipient with a frame for viewing the video to the intended recipient designated by the sender. The video is then streamed to the recipient when the recipient decides to view the email. In the present invention, no translation from the server is required because the recipient's computer already has the video reading program functionally within the computer operating system. In this sense, the preferred embodiment of the present invention is not intended to respond to every operating system, but only those having capability to read ASF video standard. The '863 patent's smart server must maintain a capability to query the recipient's computer to determine which format is acceptable. The present invention is simpler and avoids this activity by using a single format capable of being read by the ASF enabled operating system. The video screen to view the video is not embedded on the email web site, but rather is part of the recipients system inherent in the Windows operating system. The present invention further does not enable a calendar.

U.S. Pat. No. 5,953,506 to Devendra Kalra, et al. on Sep. 14, 1999 discloses a method and apparatus that provides a scalable media delivery system in the form of scalable, streamed digital data. The method of the invention does not teach the use of email, but rather a more traditional web server used in a manner that first determines multimedia characteristics of the recipient computer in order to function. Video streams accessed from the server are tailored to match the profile of each client computer so that the best combination of streams is used. The present invention is different in using delivery through email, avoiding any query to the recipient computer as to video format capability and in the software to account for the email delivery service.

Subscriber services for video mail are known, but generally control the delivery time and are not subject to delivery upon demand of the recipient. For example, U.S. Pat. No. 5,557,320 to Mark Krebs on Sep. 17, 1996 discloses a video mail delivery system sending a file in executable form. The executable form is needed so that it plays on the recipient computer without any resident video player. The '320 invention is a sender-subscriber based, transmission traffic control system for video mail, which includes the transmission of bulk electronic data primarily in the form of still or motion picture images. There are variable bandwidth controls on a per transmission basis. A delivery network system provider often a subscriber service in which the network has absolute control over the actual time of the video mail transmission. The path, bandwidth allocation, protocol format, and other means of transmission, such as wireless, satellite, analog, can be set at the discretion of the network provider. The object of this invention is to control bandwidth traffic and cost economy by regulating when the video is transmitted. The managing network provider determines transmission time itself.

While the present invention is a subscriber-based system, it is significantly different in that it does not send a file in executable form. Rather a streaming file is sent to the recipient employing the inherent video playback functions on the recipient's electronic device. The present invention is not a transmission traffic control system and is not intended to control the transmission time as these are necessary primarily for a television based system. The network provider does not exercise transmission time control, but this is instead controlled by the recipient of the email.

Prior art is also known to teach an email system with a video email player. This system, however, also uses and delivers an executable video file. Illustrative of this prior art is U.S. Pat. No. 6,014,689 Daniel C. Budge, et al. on Jan. 11, 2000. According to the '689 invention, video messages are created in a manner that allows transparent delivery over any electronic mail system. A player is selectively attached to the video message file to create an executable file, which can be delivered as a standard binary file over conventional communications networks. To view the received video email, the recipient executes the received file and the attached player automatically plays the video and audio message or the recipient executes the previously installed player, which plays the video message.

The present invention uses a regular email program and system and does not create an executable file. The preferred embodiment of the present invention requires special software that converts the video format to the ASF format and optionally allows editing of the video. In the preferred embodiment, the present invention further does not send the message with the attachment directly to the recipient. Rather, for this embodiment, a recipient views a streaming email and at no time is conveyed the entire video so that it could be viewed independently of the server.

Accordingly, the present invention will serve to improve the prior art by meeting a need to ease the process of conveying digital video images to third parties. The invention describes a service that can be rendered to digital video camera owners to permit them to easily and quickly share their videos in whatever format with others who have only the standard operating system software that enables the ASF format, or other chosen format. The present invention provides an inexpensive video email service that serves the convenience of both sender and recipient of a video.

### BRIEF SUMMARY OF THE INVENTION

The invention is a video email system and service for subscribers. The system is composed of (1) video email software residing on a subscriber's computer; (2) a server maintained by a provider to manage each subscriber's account and to stream the video on demand to an email recipient; and (3) a recipient computer capable of translating the pre-determined video file format and receiving email using any standard email program.

The service enables a subscriber using the video email software to send a digital video made with any camera and converted by the software to the pre-determined video file format to a recipient having a standard email program through the service provider's server. The server receives the video and sends a gateway email to the recipient with a frame for viewing the video. The server streams the video to the recipient upon demand of the recipient. The recipient then views a streaming email.

### BRIEF DESCRIPTION OF THE DRAWINGS

FIG. 1 is a flow diagram of the preferred embodiment of the system of the invention.

FIG. 2 is a flow diagram of the preferred embodiment of the method of using the invention.

### DETAILED DESCRIPTION

The drawings and the embodiments of the present invention disclosed herein are exemplary of the invention, which may be embodied in other forms. Therefore, the details disclosed herein are not to be interpreted as limiting the invention, but merely as the basis for the claims and as a basis for teaching one skilled in the art how to make or use the invention.

To simplify the examples given herein, this description concentrates on the Advanced Systems Format (ASF) video file format as the chosen or pre-determined video file format. The scope of the invention, however, is not so limited and contemplates the use of any video file format. Typical of other existing video file formats are Windows Media Video (WMV), Motion Picture Experts Group (MPEG), Audio-Video Interleaved (AVI), and QuickTime.

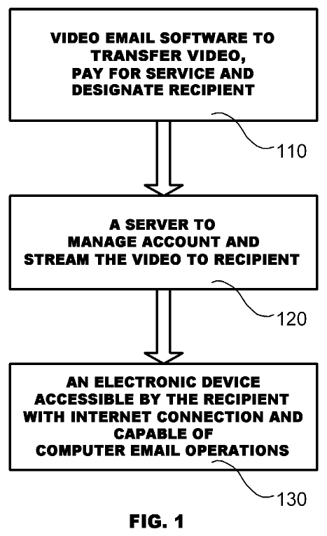

FIG. 1 is a flow diagram of the video email system. In this system, a provider of the video email system delivers digital video email service to subscribers and their designated recipients. The provider is the owner or operator of the system and the service. The provider owns or has control over the computer server and related equipment used in the email system. The provider is the owner of video email software licensed to a subscriber and used by the subscriber to send video emails. The subscriber is typically an owner of digital camera desiring to email a video file created with the camera. In order to do that the subscriber uses the video email software.

The first element of the system is, therefore, the video email software (110). The video email software is a computer program that resides on a subscriber's electronic device, capable of an Internet connection and computer email operations. Such an electronic device is generally referred to herein as a computer and typically includes a desktop or mobile computer, hand held cell phone, or digital camera.

When in use, the video email software enables the transfer of a digital video file in the pre-determined video file format from the subscriber's computer to provider's server. For the preferred embodiment, the pre-determined video file format is the ASF video file format. The software regulates subscriber's payment to the provider for streaming the digital video file to subscriber's designated recipient. The software sends an email to the recipient with a frame having controls for initiating streaming of the digital video viewing into the frame, and optionally with an alternative link to automatically stream the video to an independent viewing program on recipient's computer.

Optionally, the video email software enables the subscriber to add a text message to the email so that the recipient understands the context of the video email without having to first initiate the download stream.

Optionally, the video email software enables the subscriber to choose a frame from the available choices for delivery to a recipient. In these embodiments, frame styles are suitably styled to complement special occasions recorded in a video. Typically, the subscriber would be given the opportunity to designate a preferred default frame for delivery to a recipient.

Optionally, the video email software enables the subscriber to convert a digital video file to the pre-determined video file format, that is ASF format for the preferred embodiment. The digital video to be sent by the recipient may in some circumstances already be in the pre-determined video file format and no change in file format will be needed. In other circumstances, the file will be in the camera's native file format and will need to be converted to the pre-determined video file format. For the broadest possible utility of the invention, the video email software converts the digital video file from whatever format it is in, to the pre-determined video file format, that is ASF format for the preferred embodiment. For these and other embodiments, the video email software stores the video file in the subscriber's computer, such as on a hard drive or other internal storage medium for later access.

In some embodiments, the video email service is billed to the subscriber by the number of times a recipient accesses the streaming video. For these embodiments, the video email software permits the subscriber to designate the number of times the video can be viewed by the recipient. In other embodiments, the subscriber is charged based upon the number of videos actually sent. In other embodiments, the subscriber is charged based upon the length of video. In other embodiments, the subscriber is charged based on the size of the video file, such as in kilobytes. In yet other embodiments, the subscriber is charged extra for unlimited viewing over a specific period of time.

In other embodiments, the video email software includes video editing tools to permit the subscriber to cut unwanted segments from the video, annotate where appropriate and implement other useful edits to the video.

In some embodiments, the video email software is capable of establishing a connection to the subscriber's video camera to transfer the video to the computer. This option would simplify the transfer process for the subscriber as it eliminates the need to manually run the camera software to transfer the video. Where the video camera is equipped with a means for connecting to the Internet and performing computer email operations, the software would reside on the video camera.

The second element of the system is a server to manage the subscriber's account and stream the video to subscriber's designated email recipient (120). The server is maintained by the provider. It manages each subscriber's account in terms of keeping contact information, options applicable to the service, and managing the subscriber's payment for the service. In some embodiments, the server manages the deletion of the subscriber's video file pursuant to directions from subscriber. The server receives and stores the emailed digital video file from subscriber when sent to a designated recipient by the subscriber using the video email software. The server then sends an email message to the designated recipient's email address with a frame for viewing the digital video file in a streaming mode when requested by the recipient. The server streams the video to the recipient inside the frame when the recipient's email program permits such action and permits the recipient to click on a direct link to the video file on the server for initiating streaming of the video to a separate video viewing program on recipient's computer when the recipient's email program does not permit viewing inside the frame. In either case, the server streams the video on demand of the recipient.

The third element in the system is an electronic device accessible by the recipient (130). Similarly to the subscriber's electronic device, the electronic device accessible by the recipient must be capable of an Internet connection and computer email operations, is generally referred to herein as a computer and typically includes a desktop or mobile computer, hand held cell phone, or digital camera. In this regard, the electronic device is intended to encompass any electronic device capable of receiving it.

The electronic device accessible by the recipient has an operating system capable of translating a video file in the pre-determined video file format, that is the ASF format for the preferred embodiment, and receiving email using any standard email program. For the preferred embodiment, these conditions are met with the overwhelming majority of computers today. The recipient need not have any special software other than the normal and usual email software commonly available without charge from several different providers. The recipient's computer may alternatively use one of the many independent video viewing programs capable of viewing a digital video file in the pre-determined video file format. The independent video viewing programs are also commonly available free of charge for most computers.

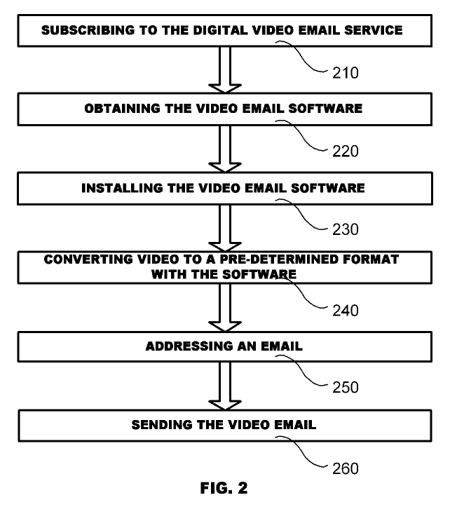

FIG. 2 is a block diagram of an embodiment of the method of using the invention. While generally speaking the method of the invention is preferably performed in the order of the steps given, it is within the scope of the invention to vary the order of the steps when convenient to the provision of video email service in accordance with the invention.

The first step (210) is subscribing to the digital video email service from the provider wherein subscribing includes providing registration information to the provider so as to enable the acquisition of the video email software from the provider and further includes purchasing credits from the provider for sending streaming video emails. Thus, a person desiring to send a video email message to an email recipient subscribes to the digital video email service. The person would contact the provider and supply the registration information including an initial payment.

The payment entitles the use of the video email services for a designated number of times. Alternatively, payment would entitle the use of the video email services measured by the number of videos actually sent, the length of video, the size of the video file, or unlimited viewing over a specific period of time. This may be accounted for in terms of credit or some other convenient method of accounting for the person's use of the service. Subscribing authorizes the person to download the video email software from the provider, or make other arrangements to acquire it, such as for delivery of the software on a disk through the mail.

The next step (220) is obtaining the provider's video email software. The subscriber obtains the video email software either directly from the provider or from a third party download site authorized by the provider. Typically, the subscriber would download the software using the Internet pursuant to the authorization given in the subscribing step. In some circumstances, the subscriber would obtain the video email software on a disk from the provider.

In alternative embodiments, the video email software will be pre-loaded in the subscriber's electronic device at the time of purchase. The subscriber will, therefore, already have the software and will not have to acquire it or install the software.

The next step (230) is installing the video email software on a computer that is capable of sending an email. Ideally, the computer is one that is operating with the capability to view a video file in the pre-determined video file format. This latter capability is not absolutely necessary as the video email software will function, but will not permit viewing the digital video file unless the subscriber's computer enables viewing of a digital video file in the pre-determined video file format. As with most programs, the video email software would install upon the subscriber running the software acquired from the provider. As part of the installation, the subscriber enters into the program the critical identification information about the subscriber, the address of the provider's mail server, and such other information as is typical to enable an email program to operate. The video email software will only work if the computer is actually capable of sending an email and this is possible only if the computer is connected to the Internet, or can be so connected, for example by using dialup Internet service, in order to be able to send an email.

Optionally, the method of the invention includes a step of converting the video to the pre-determined video file format using the video email software (240). This step provides a useful improvement to the base video email software and obviates the need for the subscriber to either use a camera that saves its video file in the pre-determined video file format or to have an independent program that performs this function.

The next step (250) is addressing an email, using the video email software, to a recipient having a standard email program. This step is simply the usual task incident to sending any email, but requires the use of the video email software. As with any email program, one must first run the video email software, open a message window, and then enter the recipient address information in the address box within the email program. This step optionally includes the subscriber choosing a frame design for the gateway email from the available choices for delivery to a recipient. This step optionally includes the subscriber entering a text message to be sent to the recipient and selecting delivery options available to be selected in the video email program. The addressing step is defined to include the subscriber linking to the video file in the pre-determined video file format to upload it to the server. The step requires that one address the email to a person having a standard email program.

The recipient need not have any special email program to receive the video email, just an ordinary email program commonly found among Internet users. The video email service will work whether or not the recipient has an email program capable of viewing an embedded video file, but, according to the system of the invention, the recipient must have a computer capable of translating, that is, viewing a video file in the pre-determined video file format. This addressing step optionally includes the subscriber choosing whether or not to allow the recipient to download the video file subsequent to receiving the streamed video.

The next step (260) is sending the video email using the video email software wherein said video email will thereupon be received by the server, wherein the server sends a gateway email to the recipient with a frame for viewing the video and wherein the server streams the video to the recipient when the recipient opens the email and indicates readiness to receive the email on a computer system having capability to view a video file in the pre-determined video file format. In the sending process, the video email software commands the subscriber's computer to send the email over the Internet to the server operated by the provider. In the normal operation of the Internet, the server then receives the subscriber's video email with the video file attached. Upon such receipt, the server then sends a gateway email to the recipient. The gateway email is so named because it is an email with a frame for viewing the video file upon command from the recipient. The gateway email optionally includes the text message from the subscriber. In the sending step, the recipient of the gateway email either activates the frame commands to begin streaming the video, or clicks on a direct link to the server to stream the video to an independent video viewing program having capability to view a video file in the pre-determined video file format and residing on the recipient's computer. Optionally, the gateway email indicates how many times the recipient is authorized to view the video.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A video electronic mail system wherein a provider delivers digital video email service for subscribers comprising,
(a) video email software residing on a subscriber's electronic device so that the software
enables transfer of a digital video file in a pre-determined video file format from the subscriber's electronic device to provider's server,
regulates subscriber's payment to the provider for streaming the digital video file to subscriber's designated recipient and
permits the subscriber to designate the number of times the video can be viewed by the recipient;
(b) a server maintained by the provider to
manage each subscriber's account,
receive the emailed digital video file from subscriber,
send a email message to the recipient's email account with a frame for viewing a streaming video file, and
stream the video on demand of the recipient; and,
(c) an electronic device accessible by the recipient wherein said electronic device has an operating system capable of translating a video file in the pre-determined video file format and receiving email.

2. The system of claim 1 wherein the pre-determined video file format is selected from a group consisting of Advanced Systems Format (ASF), Windows Media Video (WMV), Motion Picture Experts Group (MPEG), Audio-Video Interleaved (AVI), and QuickTime.

3. The system of claim 1 wherein the subscriber's electronic device is selected from a group consisting of a computer, a digital camera, and a cell phone.

4. The system of claim 1 wherein the electronic device accessible by the recipient is selected from a group consisting of a computer, a digital camera, and a cell phone.

5. The system of claim 1 wherein the video email software further enables the subscriber to add a text message.

6. The system of claim 1 wherein the subscriber's payment to the provider would entitle the use of the video email services based on a measurement selected from a group consisting of the number of videos actually sent, the length of video, the size of the video file, and unlimited viewing over a specific period of time.

7. The system of claim 1 wherein the video email software establishes a connection to the video camera to transfer the video to the subscriber's electronic device.

8. The system of claim 1 wherein the video email software provides video editing tools.

9. The system of claim 1 wherein the video email software enables the subscriber to designate how many times the video may be viewed by the recipient.

10. The system of claim 1 wherein the video email software enables the subscriber to choose a frame from the available choices for delivery to a recipient.

11. The system of claim 1 wherein the video email software stores the video file in subscriber's electronic device.

12. The system of claim 1 wherein the server
enables the video to be streamed to the recipient inside the frame when the recipient's email program permits such action, and
permits the recipient to select a direct link to the video file on the server for initiating streaming of the video to a separate video viewing program on the electronic device accessible by the recipient when the recipients email program does not permit viewing inside the frame.

13. The system of claim 1 wherein the server further manages the deletion of the subscriber's video file pursuant to directions from subscriber.

14. The system of claim 1 wherein the video email software further enables converting a digital video file of a format other than the pre-determined format into a digital video file of the pre-determined format.

15. A method of using the system of claim 14 comprising the steps of,
(a) subscribing to the digital video email service from the provider wherein subscribing includes providing registration information to the provider so as to enable the acquisition of the video email software from the provider and further includes purchasing credits from the provider for sending streaming video emails;
(b) obtaining the provider's video email software;
(c) installing the video email software on subscriber's electronic device;
(d) converting the video to the pre-determined format using the software;
(e) addressing an email using the video email software to a recipient having a standard email program wherein addressing includes attaching the video to the email; and,
(f) sending the video email using the video email software wherein said video email will thereupon be received by the server, wherein the server sends a gateway email to the recipient with a frame for viewing the video and wherein the server streams the video to the recipient when the recipient opens the email on the electronic device accessible by the recipient and indicates readiness to receive the email.

16. The method of claim 15 wherein the gateway email indicates how many times the recipient is authorized to view the video.

17. The method of claim 15 wherein addressing an email includes choosing a frame design for the gateway email from the available choices for delivery to a recipient.

18. The method of claim 15 wherein addressing an email includes adding a text message to the recipient.

19. The method of claim 15 wherein the gateway email includes the text message from the subscriber.

20. The method of claim 15 wherein addressing an email includes choosing whether or not to allow the recipient to download the video file subsequent to receiving the streamed video.

21. A method of using the system of claim 1 comprising the steps of,
(a) subscribing to the digital video email service from the provider wherein subscribing includes providing registration information to the provider and purchasing credits from the provider for sending streaming video emails;
(b) addressing an email using the video email software to a recipient having a standard email program wherein addressing includes attaching the video to the email; and,
(c) sending the video email using the video email software wherein said video email will thereupon be received by the server, wherein the server sends a gateway email to the recipient with a frame for viewing the video and wherein the server streams the video to the recipient when the recipient opens the email on the electronic device accessible by the recipient and indicates readiness to receive the email.

22. The method of claim 21 wherein the gateway email indicates how many times the recipient is authorized to view the video.

23. The method of claim 21 wherein addressing an email includes choosing a frame design for the gateway email from the available choices for delivery to a recipient.

24. The method of claim 21 wherein addressing an email includes adding a text message to the recipient.

25. The method of claim 24 wherein the gateway email includes the text message from the subscriber.

26. The method of claim 21 wherein addressing an email includes choosing whether or not to allow the recipient to download the video file subsequent to receiving the streamed video.
